(19) United States
(12) Patent Application Publication
(10) Pub. No.: US 2025/0314574 A1
(43) Pub. Date: Oct. 9, 2025

(54) METHOD AND APPARATUS FOR OBTAINING INFORMATION ABOUT ENTITIES IN A LIQUID SAMPLE

(71) Applicant: Oxford University Innovation Limited, Oxford (GB)

(72) Inventor: Madhavi KRISHNAN, Oxford (Oxfordshire) (GB)

(21) Appl. No.: 18/865,725

(22) PCT Filed: May 22, 2023
(86) PCT No.: PCT/GB2023/051336

§ 371 Date: Nov. 14, 2024

(30) Foreign Application Priority Data
May 25, 2022 (GB) 2207644.2

(51) Int. Cl. G01N 15/1429; G01N 15/0205; G01N 15/1031; G01N 15/14

(52) U.S. Cl. CPC G01N 15/1429; G01N 15/0205; G01N 15/1031; G01N 15/1425; G01N 15/1459; G01N 2015/025; G01N 2015/1493

(57) ABSTRACT

Methods and apparatus for obtaining information about entities in a liquid sample are disclosed. In one arrangement, each of a plurality of entities in the liquid sample are caused to complete a predetermined trajectory along a passage containing the liquid sample. The predetermined trajectory of each entity comprises a path through a predetermined sequence of impeding regions defined by respective perturbations defined in or on one or more walls defining the passage. Each perturbation impedes progression of the entity along the predetermined trajectory in a manner that depends on the charge and/or size of the entity. A time taken for each of the entities to complete the predetermined trajectory is measured. The measured times are used to obtain information about the charge and/or size of each of the entities.

The present disclosure relates to methods and apparatus for obtaining information about entities in a liquid sample, particularly in the context of detecting the presence or absence, and/or relative concentrations, of entities of interest in the sample.

The amount of electrical charge carried by a molecule or a molecular complex is important in several disease states such as cancer, Alzheimer's and Parkinson's disease, as well as in metabolic conditions and ageing. Although molecular mass has long been measured with atomic precision, measurements of molecular electrical charge have failed to keep up. Despite several attempts at such measurement, there remain few experimental methods that permit the electrical charge of a molecular species in solution to be measured in a highly quantitative and precise fashion, and with high sensitivity.

Escape-time electrometry (ETe) has been proposed to detect single elementary charge differences between macromolecules in solution. ETe is based on creating electrostatic potential wells for single charged entities (molecules or particles) in solution in a nanoscale fluidic system. Examples of methods that use ETe are described in: Ruggeri, F., Krishnan, M. (2017) “Lattice diffusion of a single molecule in solution” Physical Review E, 96:062406; Ruggeri, F., Krishnan, M. (2017) “Spectrally resolved single-molecule electrometry” The Journal of Chemical Physics, 148:123307; Ruggeri et. al. Nature Nanotechnology “Single molecule electrometry” 2017; and Ruggeri and Krishnan, Nanoletters “Entropic trapping of a singly charged molecule in solution” 2018.

Entities of interest may be fluorescently labelled to emit a bright signal upon optical excitation. A thermally activated escape process is then observed for hundreds of molecules trapped in parallel in individual electrostatic wells using wide-field optical microscopy. A total number of escape events, N, which may typically be about 10,000 for a given molecular species, can be recorded. The average “escape time”, t_{esc}, can be determined with a precision that scales as 1/\sqrt{N}. For N=10⁴ measured escape events this implies a 1% accuracy in determining t_{esc}. Since the average escape time depends exponentially on the depth of the potential well, as given by the expression,

$${t}_{esc} = {t}_{r} {e}^{Δ F / {k}_{B} T} ,$$

and furthermore since ΔF=q_{eff}φₘ, where tₜ is a time scale representing the position relaxation time of the molecule, q_{eff} is the effective charge of the molecular species, and om is an experimental parameter determined by measurement conditions, it is possible to determine the effective charge q_{eff} with much better than 1% accuracy. This measurement accuracy fosters highly precise, sensitive detection and ability to discriminate between slightly different molecular species in solution.

It is an object of the present disclosure to provide methods and apparatus that improve the efficiency, flexibility and/or accuracy with which information about entities in liquid samples can be obtained.

According to an aspect of the invention, there is provided a method of obtaining information about entities in a liquid sample, comprising: causing each of a plurality of entities in the liquid sample to complete a predetermined trajectory along a passage containing the liquid sample, the predetermined trajectory of each entity comprising a path through a predetermined sequence of impeding regions defined by respective perturbations defined in or on one or more walls defining the passage, each perturbation impeding progression of the entity along the predetermined trajectory in a manner that depends on the charge and/or size of the entity; measuring a time taken for each of the entities to complete the predetermined trajectory; and using the measured times to obtain information about the charge and/or size of each of the entities.

Thus, a method is provided in which information about entities in a liquid sample is obtained by monitoring how long it takes for entities to complete a predetermined trajectory. Because the predetermined trajectory of each of the entities is known in advance it is not necessary to monitor the entities continuously during the trajectory. This makes it possible to measure trajectories that contain a much larger number of impeding regions (e.g., electrical potential wells) in comparison with alternative approaches that rely on continuous observation to follow trajectories. Analysing trajectories containing larger numbers of impeding regions improves measurement precision.

In some embodiments, each entity is caused to complete the predetermined trajectory at least partly by providing a flow of the liquid sample that promotes movement of the entity through the predetermined sequence of impeding regions. Biasing movement of entities by flow can be implemented simply and cheaply and is effective for directing entities along relatively long predetermined trajectories, thereby achieving high precision. This approach is also effective for a wide range of entities and sample liquids, including situations where the entities are not charged.

In some embodiments, each entity is caused to complete the predetermined trajectory at least partly by applying a biasing electrical field that promotes movement of the entity through the predetermined sequence of impeding regions. Biasing movement of entities by electrical field can be implemented in a simple and compact arrangement and provides high levels of controllability.

In some embodiments, each entity is caused to complete the predetermined trajectory at least partly by configuring each perturbation defining the predetermined sequence of impeding regions such that entities are more likely to exit each impeding region in a direction towards a subsequent impeding region in the sequence than in any other direction. The configuring of the perturbations may comprise configuring respective topographies of one or more of the walls. Biasing movement of entities by passage topography can reduce or avoid the need for external power sources and liquid pumping arrangements.

In some embodiments, the entities and/or liquid is/are configured to suppress electrostatic effects between the walls and the entities such that the time taken for each of the entities to complete the predetermined trajectory is dominated by non-electrostatic effects. Suppressing electrostatic effects enables the method to become more sensitive to other characteristics of the entities that affect how quickly the entities progress along the trajectories, such as size and/or charge.

In some embodiments, the detection of the start and end times is performed by optically exciting emission from the entity and optically detecting the emission. The method may comprise avoiding or preventing optical excitation of emission from the entities while the entities pass through impeding regions in a portion of the path between the start and end of the predetermined trajectory. Excitation of emission (e.g., by exciting fluorescent labels) can degrade and eventually destroy labels or other entities that provide the emission. Preventing excitation for a portion of the trajectories where it is not necessary to observe the entities makes it possible for the trajectories to be made longer and to include a greater number of impeding regions. As discussed above this improves measurement precision.

According to an aspect of the invention, there is provided a method of obtaining information about entities in a liquid sample, comprising: monitoring trajectories of plural different entities through respective sequences of impeding regions defined by perturbations defined in or on walls defining a passage containing the liquid sample, the monitoring performed by optically detecting the plural entities simultaneously in the same field of view of an optical device, wherein each impeding region impedes progression of the entity along a path passing through the impeding region in a manner that depends on the charge and/or size of the entity; and analysing each monitored trajectory separately to obtain information about the charge and/or size of the entity corresponding to the trajectory.

Thus, a method is provided that allows information about multiple different entities to be derived simultaneously. The method is thus capable of rapidly distinguishing between different types of entity.

In some embodiments, the liquid sample comprises known molecular binding partners to a target molecule and the obtaining of information about the charge and/or size of each of the entities comprises determining for each entity whether the entity is: an instance of the molecular binding partner that is not bound to the target molecule, thereby detecting an unbound molecular binding partner; or a molecular complex comprising an instance of the molecular binding partner bound to the target molecule, thereby detecting a bound molecular binding partner. The methodology is capable of distinguishing between unbound and bound molecular binding partners with high precision and efficiency. This may be used to detect the presence or absence of target molecules, for example in the context of a test for the presence of a disease or condition.

In some embodiments, the method comprises estimating relative proportions of the unbound and bound molecular binding partners and using the estimated relative proportions to derive a measure of affinity of the molecular binding partner to the target molecule. The method thus provides an efficient and flexible way of obtaining a measure of affinity between a molecular binding partner and a target molecule. Such information may be highly desirable in a drug development process for example.

In some embodiments, the predetermined trajectories completed by the plurality of entities comprise paths forming a loop through at least 100 degrees, optionally such that a start and end of each predetermined trajectory are adjacent to each other, optionally such that a direction of movement of entities along the predetermined trajectory at the start of the predetermined trajectory is substantially opposite to a direction of movement of entities along the predetermined trajectory at the end of the predetermined trajectory. This approach may allow the same location to be used to detect entities at the start and end of the trajectories, thereby allowing implementation of the method in a simpler and/or more compact device and/or using fewer optical components.

According to an aspect of the invention, there is provided an apparatus for obtaining information about entities in a liquid sample, comprising: a liquid containment arrangement comprising walls defining a passage for containing the liquid sample; a driving system configured to cause each of a plurality of entities in the liquid sample to complete a predetermined trajectory along the passage, the predetermined trajectory of each entity comprising a path through a predetermined sequence of impeding regions defined by respective perturbations defined in or on the walls that are each configured to impede progression of the entity along the predetermined trajectory in a manner that depends on the charge and/or size of the entity; and a monitoring system configured to measure a time taken for each of the entities to complete the predetermined trajectory.

According to an aspect of the invention, there is provided an apparatus for obtaining information about entities in a liquid sample, comprising: a liquid containment arrangement comprising walls defining a passage for containing the liquid sample; a monitoring system comprising an optical device configured to optically detect entities in the liquid sample in the passage, the monitoring system being configured to measure trajectories of plural different entities through respective sequences of impeding regions defined by perturbations defined in or on walls of the passage by optically detecting the plural entities simultaneously in the same field of view of the optical device, wherein each impeding region is configured to impede progression of the entity along a path passing through the impeding region in a manner that depends on the charge and/or size of the entity; and a data processing system configured to analyse each monitored trajectory separately to obtain information about the charge and/or size of the entity corresponding to the trajectory.

Embodiments of the disclosure will now be further described, merely by way of example, with reference to the accompanying drawings.

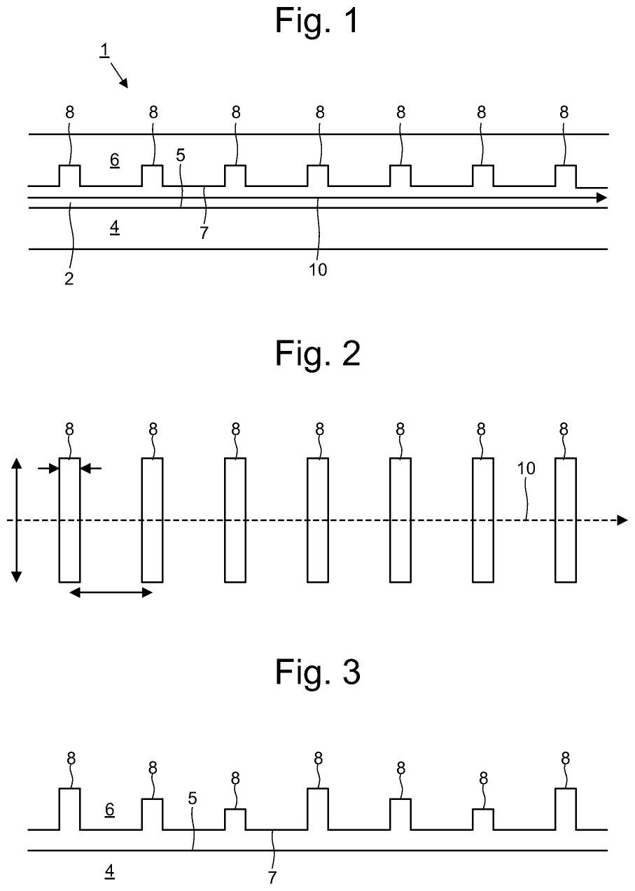

FIG. 1 is a side sectional view of a liquid containment arrangement comprising impeding regions defined by perturbations (recesses) in a wall of a passage.

FIG. 2 is a top view of the arrangement of FIG. 1 depicting example geometries of the perturbations.

FIG. 3 is a side view depicting facing surfaces of walls comprising an alternative configuration of perturbations (of variable depth).

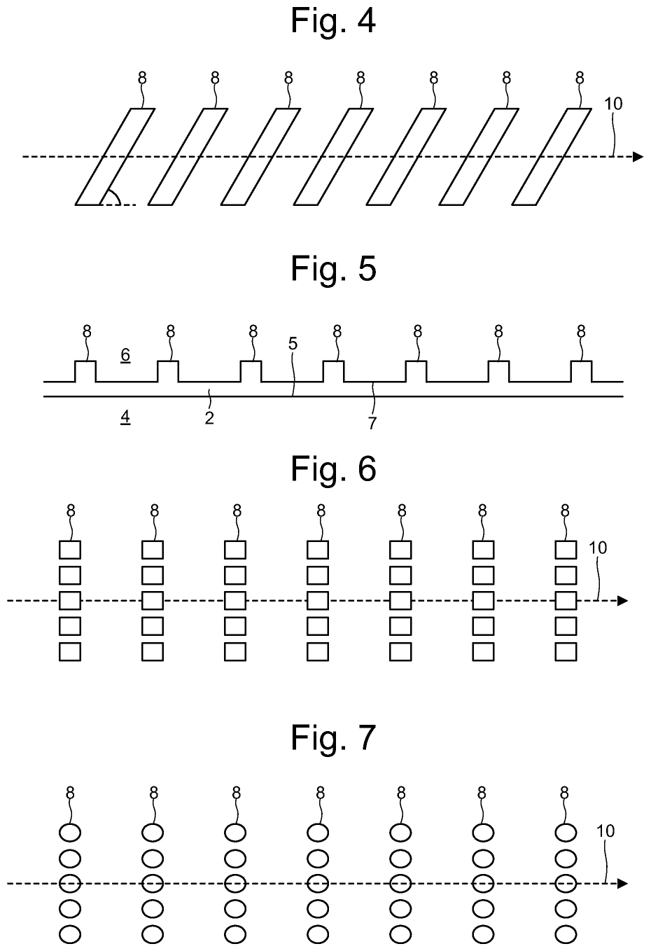

FIG. 4 is a top view of a variation on the arrangement of FIG. 2 in which elongate perturbations are aligned obliquely relative to a predetermined trajectory of entities in the passage.

FIG. 5 is a side view depicting facing surfaces of walls corresponding to the arrangement of FIG. 4.

FIG. 6 is a top view of a liquid containment arrangement in which perturbations are provided in groups of sub-perturbations.

FIG. 7 depicts a variation on the arrangement of FIG. 6 in which the sub-perturbations have an oval rather than square profile.

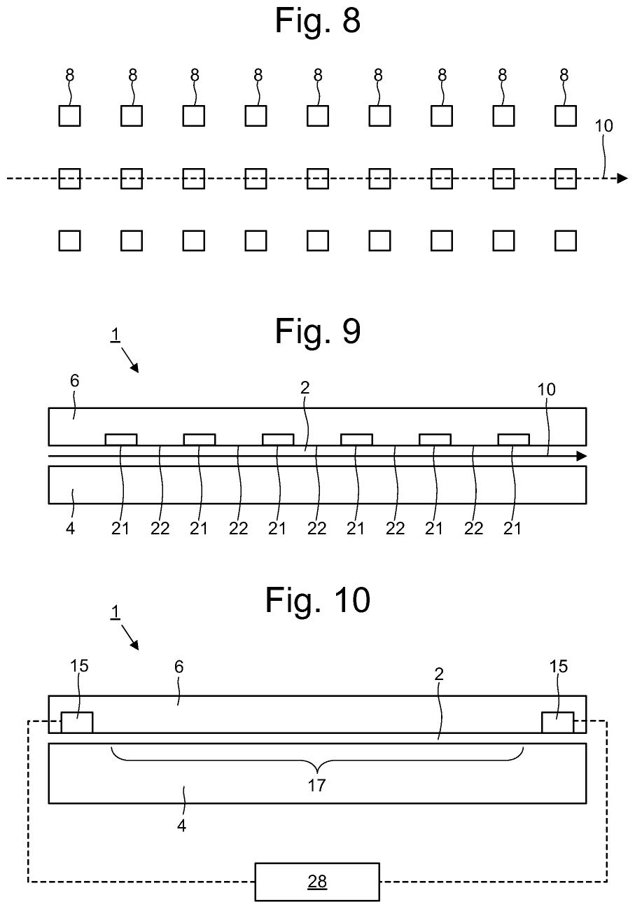

FIG. 8 depicts a variation on the arrangement of FIG. 6 in which the sub-perturbations are arranged on a regular grid.

FIG. 9 is a side sectional view of a liquid containment arrangement in which perturbations defining impeding regions are defined by a heterogeneous surface charge distribution.

FIG. 10 is a side sectional view of a liquid containment arrangement in which entities are biased to follow a predetermined trajectory along a passage by applying an electric field along the passage.

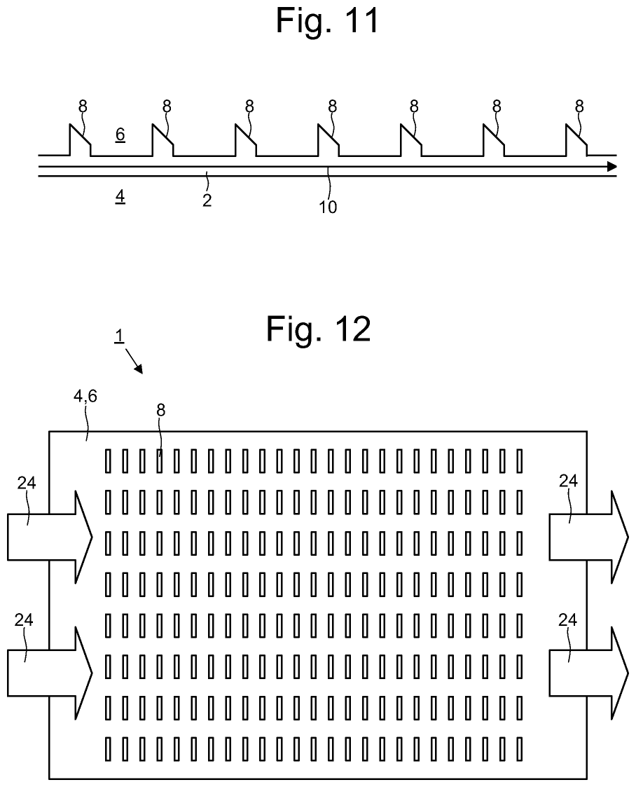

FIG. 11 is a side view depicting facing surfaces of walls of a passage in a liquid containment arrangement in which perturbations are recesses having non-uniform depth along a predetermined trajectory to bias movement of entities to follow the trajectory.

FIG. 12 is a top view of a liquid containment arrangement comprising perturbations defining plural sets of impeding regions.

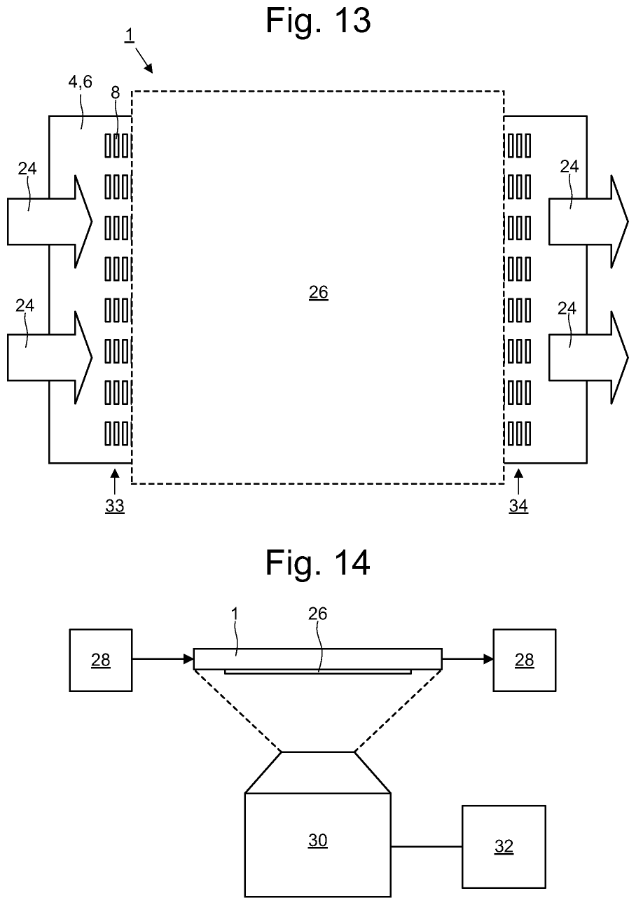

FIG. 13 is a top view of the arrangement of FIG. 12 further comprising an optical blocking arrangement.

FIG. 14 is a schematic side view of an apparatus for obtaining information about entities in a liquid sample comprising the liquid containment arrangement of FIG. 13.

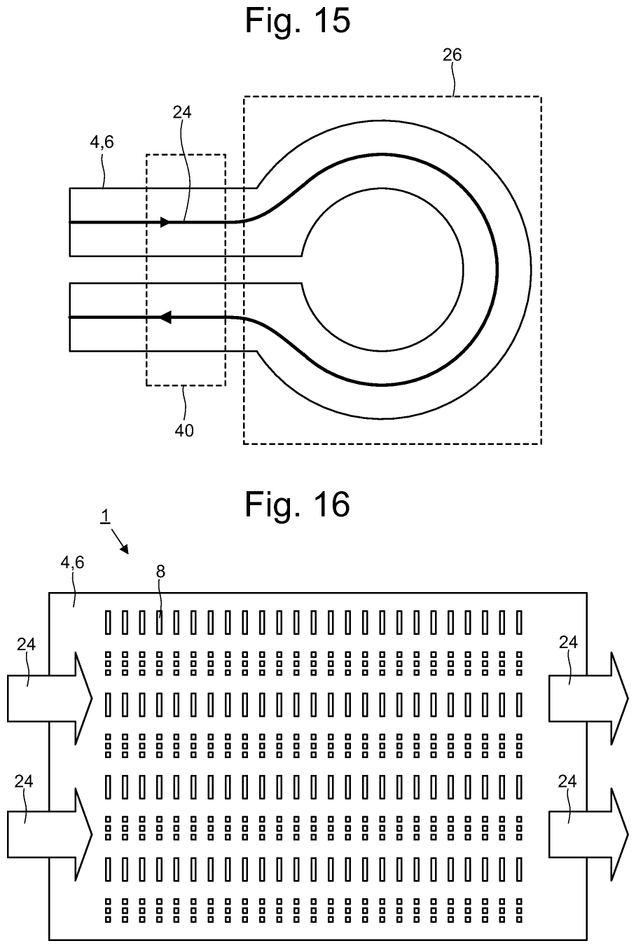

FIG. 15 is a top view of a liquid containment arrangement in which entities are biased to follow a predetermined trajectory that forms a loop.

FIG. 16 is a top view of a liquid containment arrangement comprising perturbations defining plural rows of impeding regions in which at least two adjacent rows comprise impeding regions of different type.

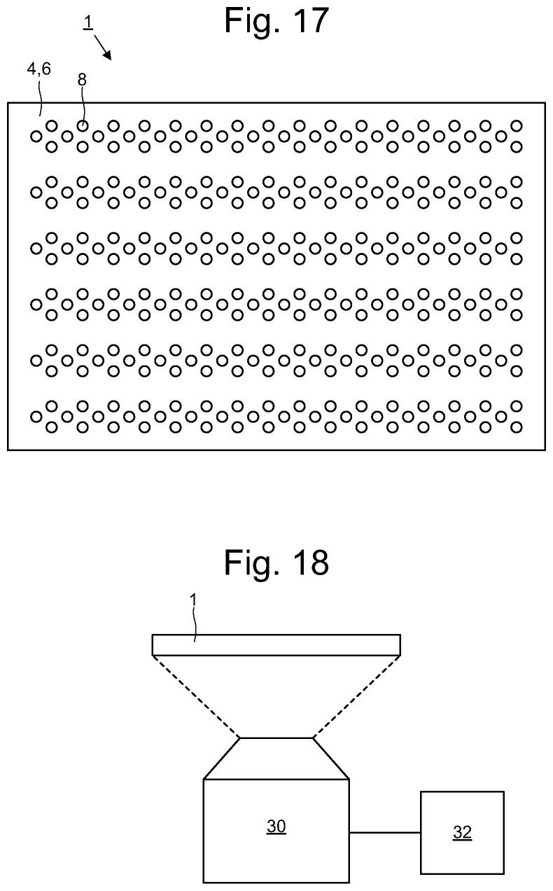

FIG. 17 is a top view of a variation on the arrangement of FIGS. 13 and 14 configured for continuous monitoring of trajectories of multiple entities in a single field of view.

FIG. 18 is a schematic side view of an apparatus for obtaining information about entities in a liquid sample comprising the liquid containment arrangement of FIG. 17.

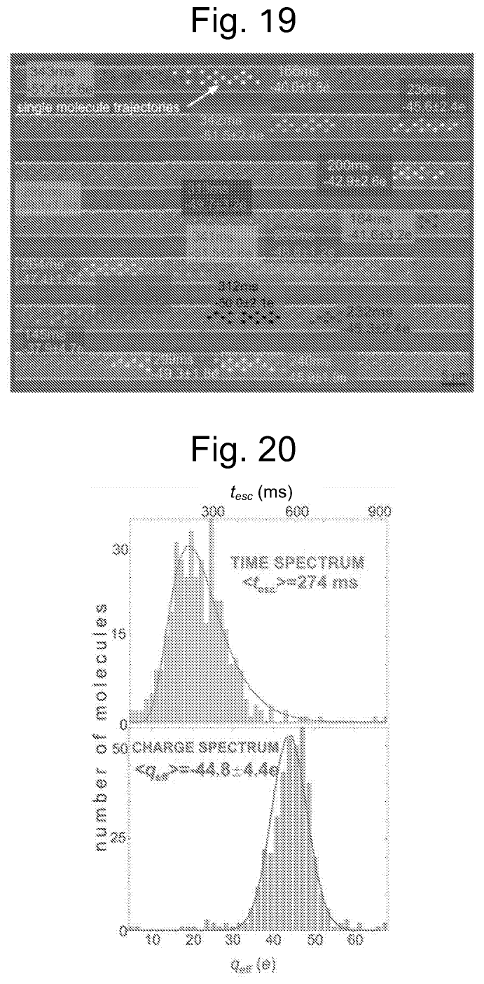

FIG. 19 shows trajectories of entities (measured using a wide-field optical microscope) superimposed on a scanning electron micrographic (SEM) view of an underlying nanostructured surface defining perturbations and impeding regions.

FIG. 20 depicts histograms presenting the distribution of measured escape times (t_{esc}−top) and the corresponding inferred effective charge (q_{eff}−bottom) for 397 molecules measured using the arrangement of FIG. 19.

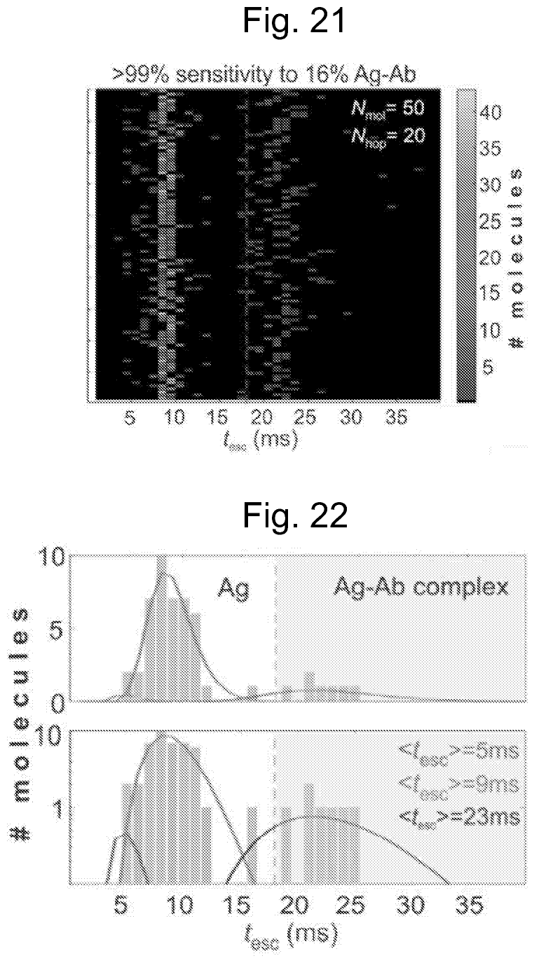

FIGS. 21, 23 and 25 are 2D histograms presenting results of 100 repeated simulation results, arrayed along the ordinate, of molecular escape times, t_{esc}, for 6 binding detection/affinity measurements under three different experimental conditions.

FIGS. 22, 24 and 26 are histograms showing representative escape time distributions from a single simulation of the three cases in FIGS. 21, 23 and 25 respectively, on both a linear (top) and logarithmic (bottom) y axis.

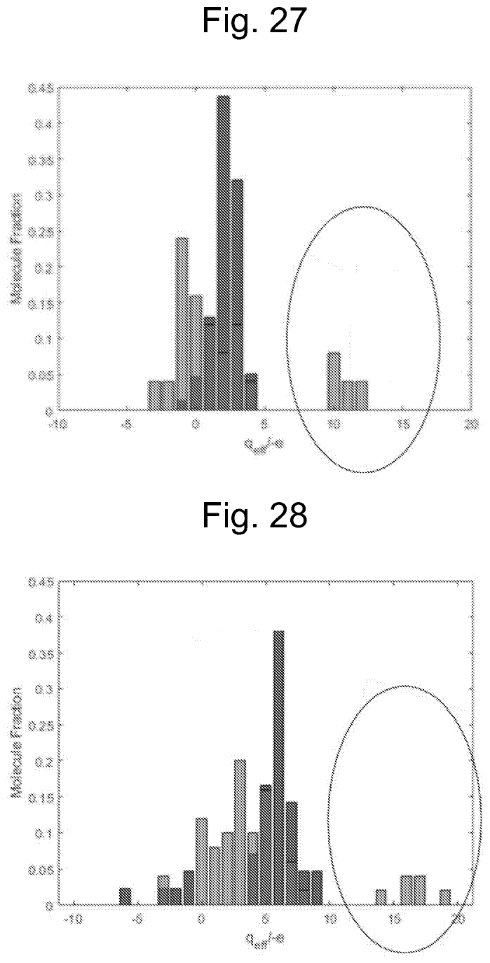

FIGS. 27 and 28 show proof-of-concept histograms demonstrating detection of binding of small fluorescently labelled Biotin molecules to a large Streptavidin protein (FIG. 27), as well as that of insulin binding to an insulin-specific antibody (FIG. 28).

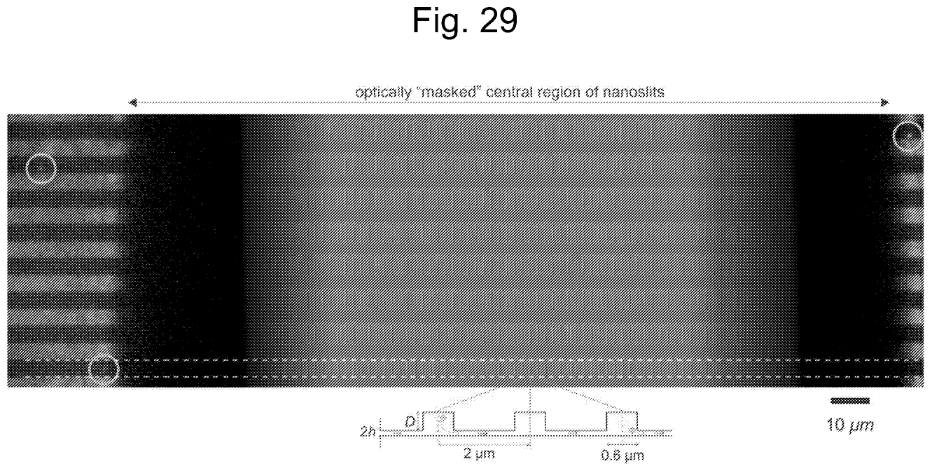

FIG. 29 is a fluorescent microscopy image of parallel fluidic nanoslits (defining impeding regions) in an arrangement of the type depicted in FIG. 13.

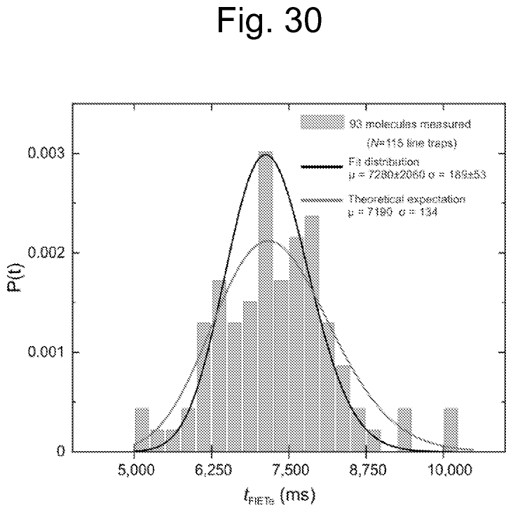

FIG. 30 is a histogram of measured transit times through predetermined trajectories defined by the arrangement of FIG. 29 for fluorescently labelled 60 basepair double-stranded DNA molecules.

The present disclosure provides methods of obtaining information about entities in a liquid sample. The entities may comprise molecules for example. The methods use a liquid containment arrangement 1 to contain the liquid sample. The liquid containment arrangement 1 comprises walls defining a passage 2 for containing the liquid sample. The walls may be transparent to allow movement of entities in the liquid sample to be monitored optically.

FIGS. 1 and 2 are schematic side and top views of a portion of such a liquid containment arrangement 1. In this example, the walls 4 and 6 define mutually facing surfaces 5 and 7. The facing surfaces 5 and 7 are each substantially planar outside and/or between perturbations 8. Thus, the facing surfaces 5 and 7 may be planar except for the perturbations 8. The planes of the facing surfaces may be parallel to each other. The passage 2 may thus be formed, for example, as a slit between plates that are parallel and planar except for the perturbations 8.

A driving system 28 (exemplified schematically in FIG. 14) is used to cause each of a plurality of entities in the liquid sample to complete a predetermined trajectory along the passage 2. The predetermined trajectory of each entity comprises a path through a predetermined sequence of impeding regions defined by respective perturbations 8 defined in or on the walls. Each perturbation 8 is configured to impede progression of the entity along the predetermined trajectory in a manner that depends on the charge and/or size of the entity. Each perturbation may impede progression of the entity predominantly via either or both of intermolecular forces between the entity and the walls (e.g., electrostatic effects, hydration effects, Van de Waals effects etc.) and entropic effects. Each perturbation 8 may create an electrostatic potential well for example. The portion of the passage 2 shown in FIG. 1 comprises seven perturbations 8. The predetermined trajectories completed by the plurality of entities may all comprise paths through a known number of impeding regions for each entity, typically the same number of impeding regions for all of the entities. Multiple sets of impeding regions may be provided to allow different entities to complete trajectories via different sets of impeding regions. It will typically be desirable that each entity experiences the same set of obstacles so that measured trajectory completion times for different entities can be compared easily. This is not essential, however, because as long as the number of impeding regions in the respective predetermined trajectory is known it will be possible to obtain information that can be compared between different entities, such as an average escape time from impeding regions encountered during the trajectory.

In the example of FIGS. 1 and 2, each perturbation 8 is defined by a recess in the upper wall 6, which defines a corresponding local deviation in topography of the facing surface 7 provided by the upper wall 6. This configuration is an example of a class of embodiment where each of one or more of the perturbations 8 comprises a respective local deviation in a topography of one or both of the facing surfaces 5 and 7. In embodiments of this type, each of one or more of the perturbations may comprise one or more recesses as in the example shown and/or protrusions. Each recess and/or protrusion provides a local deviation in topography. In the example shown, each recess has a square or rectangular cross section (as shown in FIG. 1) and is elongate in a direction perpendicular to a local portion of the predetermined trajectory 10 (where the arrow represents an average direction of movement of entities along the trajectory), as shown in FIG. 2. Each recess has the same depth in the example of FIGS. 1 and 2. In other embodiments two or more of the recesses may have different depths, as exemplified in FIG. 3. The cross-section of each recess may take forms other than square and rectangular. Where the recesses are elongate, the axes of elongation do not need to be aligned perpendicular to the trajectory 10. As exemplified in FIGS. 4 and 5, perturbations 8 may be defined by elongate recesses that are aligned obliquely to the trajectory 10.

In some embodiments, each perturbation 8 may comprise a group of sub-perturbations, as exemplified in the top views of FIGS. 6-8. In the examples of FIGS. 6 and 7, each perturbation 8 comprises a group of five recesses (arranged in a column). The shape of each recess is not particularly limited. In FIG. 6 each recess has a square profile when viewed from the top. In FIG. 7 each recess has an oval profile when viewed from the top. Other profiles are possible. In FIGS. 6 and 7, each group of recesses is separated along the trajectory 10 by a distance that is significantly larger than a separation between recesses within each group. FIG. 8 exemplifies an alternative arrangement where recesses are provided on a regular grid with the separation between recesses along the trajectory 10 being substantially equal to a separation between recesses within each group (each column of three). This arrangement may provide flexibility for operation by allowing entities to be driven along different sequences of perturbations (e.g., comprising different numbers of perturbations) by driving entities in different directions in the passage. For example, as an alternative to being driven left to right as depicted by arrow 10 in FIG. 8 the entities could be driven vertically upwards or downwards in the plane of the page, thereby encountering a different number of recesses if the number of rows in the regular grid is different to the number of columns in the regular grid. Alternatively or additionally, this arrangement or similar may allow entities to sample impeding regions in directions oblique or perpendicular to a direction along which the entities are being driven (e.g., by a flow of liquid). The sampling of regions oblique or perpendicular to flow may happen by diffusion, for example, and may be dependent on properties of the entities such as charge or size, thereby helping to provide further information about properties of the entities. For example, highly charged entities may tend to diffuse further in directions orthogonal to flow than less highly charged entities and this may affect the times taken for the entities to complete respective predetermined trajectories.

In some embodiments, each of one or more of the perturbations 8 is defined at least partially by a heterogeneous surface charge or electrical potential distribution in one or both of the walls 4 and 6. An example configuration is depicted schematically in FIG. 9, where a surface of the upper wall 6 is configured to have a composition that varies along the trajectory 10. Regions 21 of the surface have a first composition and regions 22 of the surface have a second composition different from the first composition 21. The composition of regions 21 is such that the local surface charge density in these regions is different to the local surface charge density in regions 22, when the liquid sample is present in the passage 2.

As exemplified in FIG. 14, a monitoring system 30 may be used to measure a time taken for each of the entities to complete the predetermined trajectory. This may be achieved for example by detecting a start time when the entity is present at the start of the sequence of impeding regions, and detecting an end time when the entity is present at the end of the sequence of impeding regions. Tracking the entities in this way provides information about the charges and/or sizes of the entities because the predetermined trajectory comprises a known sequence of impeding regions that impede progression of the entities in a way that depends on the charges and/or sizes of the entities.

The entities may be caused to complete their predetermined trajectories using various techniques.

In some embodiments, each entity is caused to complete the predetermined trajectory at least partly by providing a flow of the liquid sample that promotes movement of the entity through the predetermined sequence of impeding regions. For example, in the arrangements described above with reference to FIGS. 1-9, a flow of the liquid sample parallel to the trajectory 10 may be provided. Such a flow encourages entities to move in sequence through regions influenced by each of the perturbations 8 (i.e., from left to right in the plane of the page). In embodiments of this type, the flow of liquid sample may be provided by a driving system 28 (exemplified schematically in FIG. 14) that comprises any combination of elements suitable for providing the functionality, such as a pump, one or more conduits, one or more valves, one or more fluidic connection arrangements, one or more flow monitoring devices, one or more reservoirs for supplying the sample liquid to the passage 2 and/or receiving sample liquid after the sample liquid has passed through the passage 2, etc.

In some embodiments, each entity is caused to complete the predetermined trajectory at least partly by applying a biasing electrical field that promotes movement of the entity through the predetermined sequence of impeding regions. This may be achieved for example by configuring a driving system 28 to apply a potential difference between electrodes 15 in contact with the liquid sample upstream and downstream of a region 17 of the passage 2 containing the predetermined sequence of impeding regions corresponding to the predetermined trajectory, as depicted schematically in FIG. 10 (with the perturbations 8 not shown for ease of representation). The potential difference defines an electric field in the passage 2. The electric field applies a force to charged entities in the passage 2 to bias them to move along the sequence of impeding regions corresponding to the predetermined trajectory.

In some embodiments, each entity is caused to complete the predetermined trajectory 10 at least partly by configuring each perturbation defining the sequence of impeding regions such that entities are more likely to exit each impeding region in a direction towards a subsequent impeding region in the sequence than in any other direction. This may be achieved for example by configuring respective topographies of one or more of the walls. The topography of each of one or more of the perturbations 8 may be configured such that entities are more likely to exit a region associated with the perturbation 8 in a direction towards a subsequent perturbation 8 along the predetermined trajectory 10 than in any other direction. In some embodiments, as exemplified in FIG. 11, each of one or more of the perturbations 8 comprises a topographically mirror asymmetric perturbation in one or both of the facing surfaces 5 and 7 when viewed in cross-section in a direction parallel to a plane of one of the facing surfaces and perpendicular to the predetermined trajectory 10 (i.e., viewed perpendicularly into the page in the orientation shown in FIG. 11), for all mirror planes perpendicular to the predetermined trajectory 10 (i.e. all planes perpendicular to the plane of the page and intersecting a vertical line within the plane of the page). Each of one or more of the asymmetric perturbations 8 may comprise a recess having a non-uniform depth along the predetermined trajectory 10 (i.e., a depth that varies as a function of position along the predetermined trajectory 10). In the example of FIG. 11, all of the recesses have a non-uniform depth along the predetermined trajectory 10. The variation in depth favours movement of the entities through the sequence of impeding regions from left to right in FIG. 11. In the particular example shown, each recess has a depth that gets progressively smaller along the predetermined trajectory 10. A depth of each recess at a leading edge of the recess (on the right in the figure) is thus lower than a depth of the recess at a trailing edge of the recess (on the left in the figure).

In some embodiments, one or more of the impeding regions comprises an electrical potential well. The perturbations 8 may thus be configured to create respective electrical potential wells. This may be achieved by a combination of having a finite surface charge density on one or more of the walls 4, 6 defining the passage 2 and a topography (e.g., a recess) that defines an electrical potential well. The existence of an electrical potential well means that if entities are charged with an appropriate sign it may be energetically favourable for the entities to exist within the well in comparison to adjacent regions in the passage 2 outside of the well. This effect impedes movement of entities through the region influenced by the well (the impeding region) in a way which depends on the charge of the entities while they are in the sample liquid.

In some embodiments, the entities and/or liquid is/are configured to suppress electrostatic effects between the walls 4 and 6 and the entities such that the time taken for each of the entities to complete the predetermined trajectory is dominated by non-electrostatic effects. The suppression of electrostatic effects may be at least partly achieved by increasing a salt concentration in the liquid. Alternatively or additionally, the electrostatic effects may be suppressed by configuring the walls to carry little or no electric charge. This approach may allow information about aspects of the entity that are not influenced by electrostatic effects, such as size, to be obtained with higher sensitivity and/or precision. The methodology can thus be operated in two modes: one that is particularly sensitive to charge (e.g., molecular charge) and another that is particularly sensitive to size (e.g., molecular radius).

In some embodiments, a plurality of sets of the impeding regions (defined by respective perturbations 8) are provided. FIG. 12 depicts an example configuration of this type viewed perpendicularly to transparent walls defining a passage 2 for the sample liquid. The upper wall 6 comprises perturbations in the form of topographical features (e.g., recesses) that define the plural sets of impeding regions. Each row of perturbations provides one of the sets of impeding regions. Each set of impeding regions provides a different instance of the predetermined trajectory 10. The perturbations 8 shown in FIG. 12 thus provide eight sets of impeding regions and define eight corresponding instances of the predetermined trajectory 10. The sequence of impeding regions within each set may be substantially aligned with each other along a straight line. Each straight line in this example corresponds to the direction of a respective row (i.e., horizontally within the plane of the page in the example shown). The sequences of impeding regions in at least two of the sets (e.g., in at least two different rows in the example shown) are configured to allow entities to pass simultaneously along different respective instances of the predetermined trajectory 10. In the example shown, this is achieved by spacing the rows of perturbations 8 apart by a suitable amount in the column direction. In combination with application of a biasing force to promote movement of the entities along the predetermined trajectories (which in the example shown is provided by driving a flow 24 of liquid parallel to the rows of perturbations 8), different entities may thus be driven along different respective instances of the predetermined trajectory 10 (i.e., along different rows). For example, a first entity may be driven along the top row of perturbations 8 while a second entity is driven in parallel along the sequence of perturbations 8 in the next row down. This arrangement allows multiple entities to be measured simultaneously more easily.

The detection of the start and end times may be performed in various ways. In one class of embodiment, the start and end times are detected electrically. In another class of embodiment, the start and end times are detected optically. An example configuration for implementing this functionality in the context of an arrangement of the type described above with reference to FIG. 12 is depicted schematically in FIGS. 13 and 14. FIG. 13 is a view corresponding to FIG. 12 except with the addition of an optical blocking arrangement 26. The optical blocking arrangement 26 may comprise an optically opaque sheet, plate, or coating, for example, placed anywhere suitable in the optical imaging path. Other optical arrangements, e.g., involving lenses and mirrors in the illumination beam path, that realise the same effect may also be used. FIG. 14 is a schematic side view showing interactions between a liquid containment structure 1 containing the liquid sample in a passage 2 (not shown), a driving system 28 that drives the liquid sample through the liquid containment structure (such that entities in the liquid sample are driven through instances of the predetermined trajectory 10 as described above), a monitoring system 30 that measures the times taken for entities to complete the trajectories, and a data processing system 32 that analyses data output from the monitoring system 30. In the present example, the monitoring system 30 comprises an optical device configured to monitor the entities in the passage optically. Any optical arrangement that allows positions of the entities to be detected may be used (e.g., a wide-field optical microscope). The entities may be configured to fluoresce and the monitoring system 30 may excite this fluorescence to make entities of interest more detectable. The entities may, for example, be tagged with a fluorescent marker. The start and end times may thus by detected by exciting fluorescence in the entity and optically detecting the fluorescence. In some embodiments, excitation of fluorescence is avoided or prevented in the entities while the entities pass through impeding regions in a portion of the path between the start and end of the predetermined trajectory 10. In the example shown, this is achieved by the optical blocking arrangement 26. In the example shown, eight instances of the predetermined trajectory 10 are provided. The starts of the trajectories are on the left as indicated by arrow 33. The ends of the trajectories are on the right as indicated by arrow 34. The portions of the paths where excitation is prevented are the portions blocked by the optical blocking arrangement 26. Preventing fluorescence during part of the trajectories allows the trajectories to be made longer (e.g., to contain a greater number of distinct impeding regions such as electrical potential wells) while still allowing fluorescence to be excited at the end of the trajectories to enable detection. This is because observation of fluorescent labels degrades and eventually destroy the labels, effectively limiting how long the labels can be continuously observed. Escape times from the impeding regions will typically be distributed probabilistically, so averaging over a larger number of escapes improves precision.

FIG. 15 depicts a variation on the arrangement of FIGS. 13 and 14 in which the predetermined trajectories 10 (not shown) completed by the plurality of entities comprise paths forming a loop through at least 100 degrees, optionally through at least 120 degrees, optionally through at least 140 degrees, optionally through at least 160 degrees, optionally through substantially 180 degrees (as in the example shown). Thus, in contrast to the arrangement in FIGS. 13 and 14 where the predetermined trajectories 10 were straight lines, the predetermined trajectories 10 may be non-linear. In some embodiments, as exemplified in FIG. 15, the loop may be such that the start and end of each predetermined trajectory 10 are adjacent to each other. In some embodiments a direction of movement of entities along the predetermined trajectory 10 at the start of the predetermined trajectory 10 is substantially opposite to a direction of movement of entities along the predetermined trajectory 10 at the end of the predetermined trajectory 10. This may facilitate optical detection of the starts and ends of the trajectories. For example, an optical system may be configured to perform measurements within a single detection region 40. The single detection region 40 may encompass the starts and ends of the predetermined trajectories 10 therefore allowing timings of the starts and ends to be recorded. Entities may be biased by a flow 24 of liquid to flow around the loop in a predetermined sense corresponding to the direction of flow 24 (as indicated by the arrows labelled 24). As can be seen, in the upper part of the detection region 40 entities will move to the right (biased by the flow) and in the lower part of the detection region 40 entities will move to the left. The upper and lower parts of the detection region 40 thus respectively record the starts and ends of the predetermined trajectories 10 in a single location. The direction of movement of entities are thus opposite to each other at the starts and ends of the predetermined trajectories 10 in this example. Portions of the predetermined trajectories 10 outside of the detection region 40 may be protected from excitation of emission by an optical blocking arrangement 26, in the same way as in the arrangement of FIGS. 13 and 14.

FIG. 16 depicts a variation on the arrangement of FIG. 12 in which the impeding regions are arranged in rows parallel to the predetermined trajectories and at least two adjacent rows comprise impeding regions of different type. In the example shown, rows alternate between a row having impeding regions defined by perturbations 8 of the type depicted in FIG. 2 and described above and a row having impeding regions defined by perturbations 8 of the type depicted in FIGS. 6-8 and described above. Various other arrangements are possible.

FIGS. 17 and 18 depict a variation on the arrangement of FIGS. 13 and 14 in which multiple entities in a sample liquid are still measured in parallel but without requiring the entities to be driven to pass through a predetermined trajectory defined by a specific sequence and/or number of impeding regions corresponding to perturbations 8. Instead, entities are allowed to propagate between impeding regions in a more random order and monitored within the same field of view of an optical system. In embodiments of this type, an apparatus is provided that comprises a liquid containment arrangement 1. The liquid containment arrangement 1 comprises walls 4, 6 defining a passage 2 for containing the liquid sample. The liquid containment arrangement 1 and walls 4, 6 may take any of the forms described above with reference to FIGS. 1-16. In the example shown, the liquid containment structure 1 comprises mutually facing walls 4 and 6. The apparatus comprises a monitoring system 30. The monitoring system 30 comprises an optical device (e.g., a wide-field optical microscope) configured to optically detect entities in the liquid sample in the passage 2. The monitoring system measures trajectories of plural different entities through respective sequences of impeding regions defined by perturbations 8 defined in or on walls of the passage 2 by optically detecting the plural entities simultaneously in the same field of view of the optical device. As described above, each impeding region impedes progression of the entity along a path passing through the impeding region in a manner that depends on the charge and/or size of the entity. The apparatus further comprises a data processing system 32. The data processing system 32 analyses each monitored trajectory separately to obtain information about the charge and/or size of the entity corresponding to the trajectory. The analysis of each monitored trajectory may comprise determining information about residency times or escape times of the entity from perturbations 8 along the trajectory.

FIG. 19 depicts example observed trajectories of different entities as they move between perturbations 8 corresponding to different impeding regions in an implementation of the type described above with reference to FIGS. 17 and 18. In this example, each perturbation 8 was defined by a circular recess in one of two facing walls 4, 6. The perturbations 8 were grouped into sets that each contained three closely spaced rows of perturbations 8. Seven such sets are depicted in FIG. 19. The entities were fluorescently labelled 60 base pair double-stranded DNA. FIG. 19 shows trajectories of these entities (measured using a wide-field optical microscope) superimposed on a scanning electron micrographic (SEM) view of the underlying nanostructured surface defining the perturbations 8 and impeding regions. Individual trajectories are depicted in different shadings and the labels in each case quote measured escape times, t_{esc} (top) and inferred effective charge values, q_{eff} (bottom), of the entities.

FIG. 20 depicts histograms presenting the distribution of measured escape times (t_{esc}−top) and the corresponding inferred effective charge (q_{eff}−bottom) for 397 molecules measured. The presented histogram includes all molecules or individual trajectories for which the number of transitions Nₕₒₚ between different impeding regions, which may be referred to as trapped events or hops, is greater than 6 (Nₕₒₚ>6) and which reveals a single molecular species. The precision on the escape time is statistically limited and scales as 1/\sqrt{Nₕₒₚ}. This gives a precision of about 10% on t_{esc} and about 3% on q_{eff} assuming the ability to record Nₕₒₚ=100 for each molecule. A single trajectory of 20 hops, collected within about 2 s, gives sufficient information to measure the charge of a single entity to within 10% and its hydrodynamic radius to within about 20%.

Thus, a method is provided in which single molecules migrating in a lattice of geometry-induced traps (impeding regions defined by perturbations 8) are individually tracked “hopping” through the landscape in a highly parallel fashion. This approach supports high throughput single molecule tracking, allowing construction of histograms of average escape times, t_{esc}, for individual molecules in a large ensemble. Each molecule gives an independently trackable signal recorded by the optical device. This makes it possible to measure the average escape time over the length of the trajectory for each individual molecule, with each trajectory composed of a variable number of hops, Nₕₒₚ, each of residence time Δt. This average escape time measured for each trajectory, t_{esc}, can be converted to an effective charge, q_{eff}, of that individual molecule. Therefore the charge (or hydrodynamic radius) of each and every molecule can be determined independently.

The approach described above with reference to FIGS. 1-16, in which entities are caused (e.g., by liquid flow, electric field, topography, etc.) to move through a predetermined trajectory makes it possible to controllably subject different entities to trajectories that involve a number of impeding regions (and therefore hops) that is known in advance, typically exactly the same number of impeding regions for all of the measured entities. This means that it is no longer necessary to monitor the entities continuously. It is sufficient to record the times when an entity starts and ends the predetermined trajectory. Thus, the entity only needs to monitored at the start and end of the trajectory. As mentioned above, this obviates the need for frequent observation/continuous optical observation which tends to destroy the fluorescent label fairly quickly. In fact the limited viability of the label typically restricts the value of Nₕₒₚ to be about 100, thereby limiting the measurement precision. In comparison, the approach of FIGS. 1-16 allows Nₕₒₚ to be much higher, for example as high as Nₕₒₚ=1000 or more, which enables measurements with 1% precision per molecule or better. This supports superior spectra and state discrimination ability than the “random-hopping” approach of FIGS. 17-18.

The methods and apparatuses described above allow information to be obtained about the charges and/or sizes of entities in a liquid sample with high precision and/or throughput. In some embodiments, these approaches are exploited in the context of a liquid sample that comprises known molecular binding partners to a target molecule and the obtaining of information about the charge and/or size of each of the entities comprises determining for each entity whether the entity is 1) an instance of the molecular binding partner that is not bound to the target molecule, thereby detecting an unbound molecular binding partner; or 2) a molecular complex comprising an instance of the molecular binding partner bound to the target molecule, thereby detecting a bound molecular binding partner. At least one of the molecular binding partners may be optically labelled to assist with monitoring of trajectories. The above functionality may be referred to as affinity electrometry. The approach can be used to detect the presence or absence of a molecule of interest in a complex mixture of molecules.

The association or binding of two different molecules A and B leads to a shift in properties of the molecular complex (which may be referred to as “AB”) compared to those of either A or B. Almost always the size of the AB complex will be larger than that of either A or B, and the charge state of the AB complex is also different from either “parent” molecule. A change in size and/or charge will imply a change in the rate of transport or hopping of the molecular complex through the sequence of impeding regions defined by perturbations 8 (e.g., a trap landscape). High precision measurement of the hopping process for each molecular entity reveals the properties of each and/or allows them to be distinguished from each other or from other entities present in the sample.

In an example implementation, species B is optically labelled to enable detection and used as molecular “bait” to associate with its binding partner, the molecular species A of interest, in solution in the liquid sample. A on its own is optically invisible in the sample, but the bait, B, is labelled and optically visible against a dark background of a host of other molecular species in the mixture. When A and B encounter each other, they create the molecular complex AB. This renders molecule A optically visible by association (because B is visible). The principle can be applied to any molecule of interest A, provided a binding partner to A is known and can be optically labelled. The optical label on B is essential in this case as it permits only the molecular species of interest (i.e., free bait B and/or bound complex AB) to be visible to us, sticking out from what would otherwise be an overwhelmingly large sea of background signals from a plethora of molecular species typically constituting a protein mixture. For example, consider using fluorescently labelled SARS CoV2 Spike S1 protein as molecular bait (B) to fish out Antibodies (A) in a small volume of patient derived serum sample, signalling prior exposure to the virus. In the absence of antibodies in the serum, the bright bait molecules are free of binding partners and migrate rapidly through the landscape. In the presence of A molecules in the serum, complexes of A and B that form migrate much slower than free B, as antibodies A tend to be both very large in size and highly charged compared to a judiciously chosen bait B molecule. Thus the approach can serve a purely detection-based function where the presence or absence of a species of interest is qualitatively assessed.

As an extension, in some embodiments the methodology further comprises estimating relative proportions of the unbound and bound molecular binding partners and using the estimated relative proportions to derive a measure of affinity of the molecular binding partner to the target molecule. Referring to the example above, this could involve counting the number of free B molecules and bound AB detected. The measure of affinity may be expressed as an “association constant” or “affinity constant”. Such measures of affinity are of great importance in molecular interactions. Pharma and biotech companies need to know the value of this parameter in a molecular interaction in order to fine tune the properties of the drugs they synthesize.

The approach may be applied to a wide range of combinations of molecular binding partner and target molecule. The molecular binding partner and target molecule may for example be selected from one or more of the following pairs: an antigen and a corresponding antibody, such as insulin and anti-insulin immunoglobulin; and a small molecule and a protein target, such as a drug molecule and a protein target.

In order to illustrate the power of the method in constructing high resolution charge and/or size spectra, simulation based analyses were performed of a representative problem of a large antibody Ab (molecular weight 150 kDa, hydrodynamic radius, r_{H}=5 nm) binding to a small fluorescently labelled antigen Ag, e.g., a peptide hormone such as insulin with a molecular weight of 5.8 kDa and r_{H}˜1 nm. The results are depicted in FIGS. 21-28.

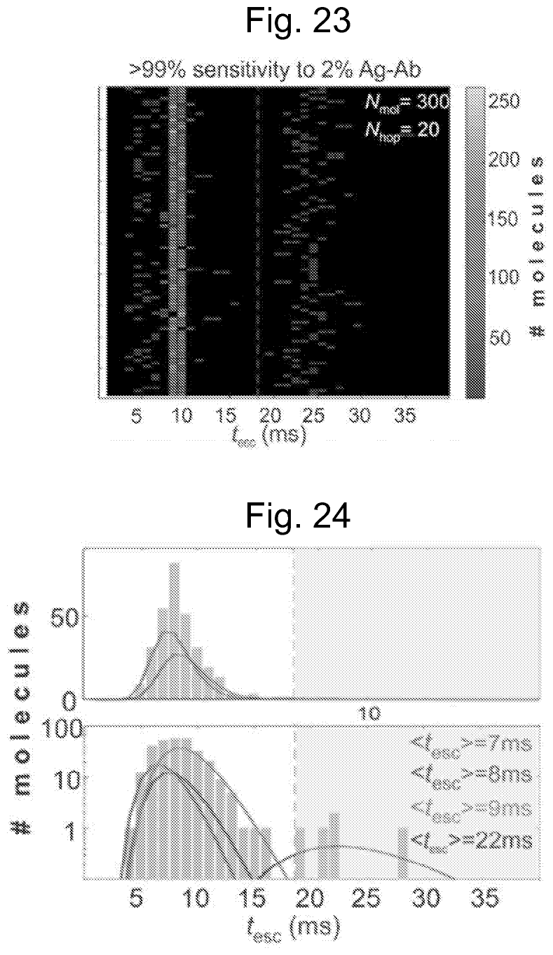

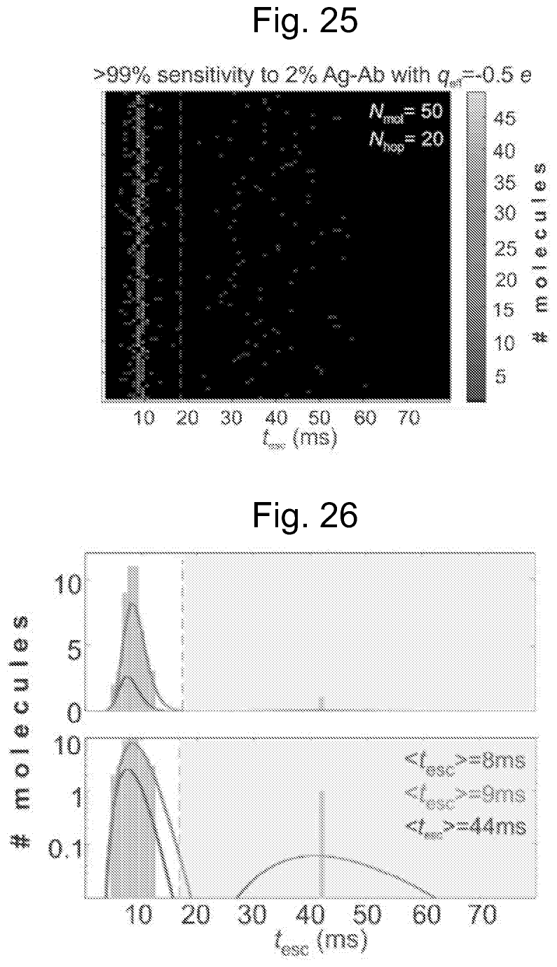

FIGS. 21, 23 and 25 are 2D histograms presenting results of 100 repeated simulation results, arrayed along the ordinate, of molecular escape times, t_{esc}, for 6 binding detection/affinity measurements under three different experimental conditions. Two different affinities were considered (denoted by 2% and 16% Ag-Ab bound for the same concentration of Ag) entailing either no electrostatic contribution to the overall electrical potential well depth associated with each perturbation, i.e., ΔF=0 and physiological salt concentration in solution (FIGS. 21 and 23), or a third case (FIG. 25) which includes a weak electrostatic contribution from the charge of the complex (q_{eff}=−0.5 e and ΔF=1.3 k_{B}T in 0.1 mM NaCl solution) for the same molecular binding affinity shown in FIG. 23. 20 trapped events or hops (Nₕₒₚ) were simulated for each molecular entity (free Ag or Ag-Ab complex) in the study. The abscissa of the plots denote the average escape times, t_{esc}, obtained for each detected fluorescently emitting entity in solution. The dashed vertical line in FIGS. 22, 24 and 26 indicates a threshold value of the escape time that serves as a metric for the detection of the presence of Ag-Ab complex (t_{esc}<18 ms for 0% Ag-Ab with >99% confidence), whereby any escape dynamics observed with t_{esc}>18 ms indicates the presence of Ag-Ab complex. A detection sensitivity criterion, S, is defined as

$$S > \frac{M}{{M}_{t o t} + 1} ,$$

where M denotes the number of measurements or simulations that detect an Ag-Ab complex, and Mₜₒₜ is the total number of performed measurements. S>99% is ascertained in the case where all 100 repeats yield a detected entity characterised by t_{esc}>18 ms. The required number of measured entities, Nₘₒₗ, to yield S>99% in each case is quoted. The total number of entities for the study in FIG. 21 is 5000. Importantly, as the affinity of the interaction increases, Nₘₒₗ decreases (compare FIGS. 21 and 23). Presence of a small amount of electrical charge on the bound complex significantly enhances the performance by reducing the number of entities, Nₘₒₗ, required to reliably achieve S>99% (compare FIGS. 23 and 25).

FIGS. 22, 24 and 26 show histograms respectively corresponding to FIGS. 21, 23 and 25. The histograms show representative escape time distributions from a single simulation of the three cases in FIGS. 21, 23 and 25 on both a linear (top) and logarithmic (bottom) y axis. Gaussian distributions, fitted keeping number of components free, illustrate the possible species present in the measurement. The species detected are characterised by their mean escape time values (quoted in the legend), with the species fraction of the component given by a line shading following that of the 2D histogram scale in FIGS. 21, 23 and 25. Any molecule with behaviour t_{esc}>18 ms is deemed to be Ag-Ab complex with >99% confidence. The fit values of component fractions permit a direct measurement of the binding affinity.

As mentioned above, where electrostatic effects are present in the passage 2, the methodology of the present disclosure allows sensitive measurements to be made of the charge characteristics of entities in a sample in the passage 2 due to the repulsive electrical interaction energy experienced by the entities due to the walls and perturbations formed therein. FIGS. 21 and 23 demonstrate how the technology can be operated in two modes: one that is highly sensitive to molecular charge and another which is sensitive to molecular size. The latter mode is achieved by suppressing electrostatic effects through the use of high salt concentration in solution, or by using surfaces that carry little or no electrical charge. Here the time spent by molecules in the traps in a landscape, in the absence of any contribution from charge (electrostatics), should reveal molecular size. The effectiveness of the latter mode is demonstrated by the results discussed above with reference to FIGS. 21 and 23.

FIGS. 27 and 28 show proof-of-concept histograms demonstrating detection of binding of small fluorescently labelled Biotin molecules to a large Streptavidin protein (FIG. 27), as well as that of insulin binding to an insulin-specific antibody (FIG. 28). In both cases, the sample containing the mixture of fluorescently labelled molecular bait (either Biotin or Insulin) and the molecule of interest (either Streptavidin or Anti-Insulin IgG) displays a small, weakly charged and fast species representing the bait, and a larger, strongly charged, slower species. The graphs demonstrate that the methodology of capable of distinguishing between the bait and the larger, strongly charged, slower species (represented by the bars in the respective circled regions of the graphs).

The representative simulation results of the expected escape time spectrum for antigen/antibody binding show that changes of the order of a factor 2 or 3 that occur in the hydrodynamic radius of a large antibody (r_{H}˜5 nm) binding to a small antigen molecule (r_{H}˜1-2 nm) can be evident from an examination of a mere 50 entities—either free antigen or bound antigen-antibody complex—in solution. If the antibody carries a net electrical charge, the difference in escape times between the bound and unbound species becomes even larger (factor 20 or more), permitting facile discrimination—even just by direct visual inspection—of the two species within a few seconds. Because the approach is based on directly counting every single labelled entity in solution, namely antigen in the free or complexed state, the technique also directly provides a sensitive measure of intermolecular binding affinities.

FIGS. 29 and 30 depict experimental realisation of an arrangement of the type depicted in FIG. 13. FIG. 29 is a fluorescence microscopy image of a landscape of traps comprising parallel fluidic nanoslits (defining rows of perturbations with each row defining a predetermined trajectory). In this example the landscape of tracks is provided in a region that is optically protected by an optical blocking arrangement. The central darkened region of the image shows how single molecules (examples highlighted in circles) are prevented from being optically excited when they are within the landscape of traps (protected by the optical blocking arrangement). Molecules are optically excited and detected on entry (left) and upon exit (right) from the region containing the landscape of traps. The time measured for this transit is recorded. Superimposed on the optical microscopy image is a scanning electron micrograph (SEM) of a section of eight rows of “line” traps responsible for impeding the motion of molecules through the darkened lattice. FIG. 30 is a histogram of measured transit times for fluorescently labelled 60 basepair double-stranded DNA molecules passing through a region of the device containing parallel rows of N=115 line traps in series. The measured distribution of passage times agrees well with the theoretically expectation, with mean values denoted by μ and standard deviation denoted by σ. Molecular species with ˜10-15% disparity in mean transit time values can be readily distinguished, which can imply 3-5% differences in charge for strongly charged molecules.

The project leading to this application has received funding from the European Research Council (ERC) under the European Union's Horizon 2020 research and innovation programme (grant agreement No 724180).

1. A method of obtaining information about entities in a liquid sample, comprising:
causing each of a plurality of entities in the liquid sample to complete a predetermined trajectory along a passage containing the liquid sample, the predetermined trajectory of each entity comprising a path through a predetermined sequence of impeding regions defined by respective perturbations defined in or on one or more walls defining the passage, each perturbation impeding progression of the entity along the predetermined trajectory in a manner that depends on the charge and/or size of the entity;
measuring a time taken for each of the entities to complete the predetermined trajectory; and
using the measured times to obtain information about the charge and/or size of each of the entities.

2. The method of claim 1, wherein the perturbation impedes progression of the entity predominantly via one or any combination of the following: intermolecular forces between the entity and the walls; entropic effects.

3. The method of claim 1, wherein each entity is caused to complete the predetermined trajectory at least partly by providing a flow of the liquid sample that promotes movement of the entity through the predetermined sequence of impeding regions.

4. The method of claim 1, wherein each entity is caused to complete the predetermined trajectory at least partly by applying a biasing electrical field that promotes movement of the entity through the predetermined sequence of impeding regions.

5. The method of claim 1, wherein each entity is caused to complete the predetermined trajectory at least partly by configuring each perturbation defining the predetermined sequence of impeding regions such that entities are more likely to exit each impeding region in a direction towards a subsequent impeding region in the sequence than in any other direction.

6. The method of claim 5, where the configuring of the perturbations comprises configuring respective topographies of one or more of the walls.

7. The method of claim 6, wherein:
the walls defining the passage define two mutually facing surfaces that are each substantially planar outside and/or between the perturbations; and
each of one or more of the perturbations comprises a topographically mirror asymmetric perturbation in one or both of the facing surfaces when viewed in cross-section in a direction parallel to a plane of one of the facing surfaces and perpendicular to the predetermined trajectory, for all mirror planes perpendicular to the predetermined trajectory.

8. The method of claim 7, wherein each of one or more of the asymmetric perturbations comprises a recess having a depth that varies as a function of position along the predetermined trajectory.

9. The method of claim 1, wherein one or more of the impeding regions comprise an electrical potential well, optionally formed wherein one or more portions of one or more of the walls are electrically charged.

10. The method of claim 1, wherein the entities and/or liquid sample is/are configured to suppress electrostatic effects between the walls and the entities such that the time taken for each of the entities to complete the predetermined trajectory is dominated by non-electrostatic effects, optionally wherein the suppression of electrostatic effects is achieved by increasing a salt concentration in the liquid.

11. The method of claim 1, wherein a plurality of sets of the impeding regions are provided, each set providing a different instance of the predetermined trajectory.

12. The method of claim 11, wherein:
the sequence of impeding regions within each set are substantially aligned with each other along a straight line; and/or
the sequences of impeding regions in at least two of the sets are configured to allow entities to pass simultaneously along different respective instances of the predetermined trajectory.

13. The method of claim 1, wherein the impeding regions are arranged in rows parallel to the predetermined trajectories and at least two adjacent rows comprise impeding regions of different type.

14. The method of claim 1, wherein the measuring of the time taken for each entity to complete the predetermined trajectory comprises:
detecting a start time when the entity is present at the start of the predetermined sequence of impeding regions; and
detecting an end time when the entity is present at the end of the predetermined sequence of impeding regions,
wherein, optionally, the detection of the start and end times is performed optically or electrically.

15. The method of claim 14, wherein the detection of the start and end times is performed by optically exciting emission from the entity and optically detecting the emission.

16. The method of claim 15, comprising avoiding or preventing optical excitation of emission from the entities while the entities pass through impeding regions in a portion of the path between the start and end of the predetermined trajectory.

17. The method of claim 1, wherein the predetermined trajectories completed by the plurality of entities all comprise paths through the same number of impeding regions.

18. The method of claim 17, wherein the predetermined trajectories completed by the plurality of entities are all linear.

19. The method of claim 1, wherein the predetermined trajectories completed by the plurality of entities comprise paths forming a loop through at least 100 degrees, optionally such that a start and end of each predetermined trajectory are adjacent to each other, optionally such that a direction of movement of entities along the predetermined trajectory at the start of the predetermined trajectory is substantially opposite to a direction of movement of entities along the predetermined trajectory at the end of the predetermined trajectory.

20. A method of obtaining information about entities in a liquid sample, comprising:
monitoring trajectories of plural different entities through respective sequences of impeding regions defined by perturbations defined in or on walls defining a passage containing the liquid sample, the monitoring performed by optically detecting the plural entities simultaneously in the same field of view of an optical device, wherein each impeding region impedes progression of the entity along a path passing through the impeding region in a manner that depends on the charge and/or size of the entity; and
analysing each monitored trajectory separately to obtain information about the charge and/or size of the entity corresponding to the trajectory.

21. The method of claim 20, wherein the analysis of each monitored trajectory comprises determining information about residence times or escape times of the entity from impeding regions along the trajectory.

22. The method of claim 21, wherein the presence of a selected type of entity characterized by a charge and/or size of the entity is detected by controlling the intensity of an illumination and/or tuning an exposure time of an optical detector according to the entity's residence time or escape time from the impeding regions, thus selectively rendering visible and measurable the selected type of entity in the liquid sample and not other entities in the liquid sample.

23. The method of claim 1, wherein the liquid sample comprises known molecular binding partners to a target molecule and the obtaining of information about the charge and/or size of each of the entities comprises determining for each entity whether the entity is:
an instance of the molecular binding partner that is not bound to the target molecule, thereby detecting an unbound molecular binding partner; or
a molecular complex comprising an instance of the molecular binding partner bound to the target molecule, thereby detecting a bound molecular binding partner,
wherein:
at least one of the molecular binding partners is optionally optically labelled; and/or
the molecular binding partner and target molecule are optionally selected from one or more of the following pairs: an antigen and a corresponding antibody, such as insulin and anti-insulin immunoglobulin; and any two molecules with affinity for each other such as drug molecule, protein, lipid or nucleic acid molecule and a corresponding molecular target.

24. The method of claim 23, further comprising estimating relative proportions of the unbound and bound molecular binding partners and using the estimated relative proportions to derive a measure of affinity of the molecular binding partner to the target molecule.

25. The method of claim 1, wherein the walls defining the passage define two mutually facing surfaces that are each substantially planar outside and/or between the perturbations.

26. The method of claim 25, wherein each of one or more of the perturbations comprises a respective local deviation in a topography of one or both of the facing surfaces, optionally one or more recesses and/or protrusions.

27. The method of claim 1, wherein each of one or more of the perturbations is at least partially defined by a heterogeneous surface charge or electrical potential distribution on one or more of the walls.

28. An apparatus for obtaining information about entities in a liquid sample, comprising:
a liquid containment arrangement comprising walls defining a passage for containing the liquid sample;
a driving system configured to cause each of a plurality of entities in the liquid sample to complete a predetermined trajectory along the passage, the predetermined trajectory of each entity comprising a path through a predetermined sequence of impeding regions defined by respective perturbations defined in or on the walls that are each configured to impede progression of the entity along the predetermined trajectory in a manner that depends on the charge and/or size of the entity; and
a monitoring system configured to measure a time taken for each of the entities to complete the predetermined trajectory.

29. The apparatus of claim 28, further comprising a data processing system configured to use the measured times to obtain information about the charge and/or size of each of the entities.

30. An apparatus for obtaining information about entities in a liquid sample, comprising:
a liquid containment arrangement comprising walls defining a passage for containing the liquid sample;
a monitoring system comprising an optical device configured to optically detect entities in the liquid sample in the passage, the monitoring system being configured to measure trajectories of plural different entities through respective sequences of impeding regions defined by perturbations defined in or on walls of the passage by optically detecting the plural entities simultaneously in the same field of view of the optical device, wherein each impeding region is configured to impede progression of the entity along a path passing through the impeding region in a manner that depends on the charge and/or size of the entity; and
a data processing system configured to analyse each monitored trajectory separately to obtain information about the charge and/or size of the entity corresponding to the trajectory.
